(19) United States
(12) Patent Application Publication
(10) Pub. No.: US 2025/0054693 A1
(43) Pub. Date: Feb. 13, 2025

(54) MULTILAYER ELECTRONIC COMPONENT

(71) Applicant: SAMSUNG ELECTRO-MECHANICS CO., LTD., Suwon-si (KR)

(72) Inventor: Dongseuk KIM, Suwon-si (KR)

(73) Assignee: SAMSUNG ELECTRO-MECHANICS CO., LTD., Suwon-si (KR)

(21) Appl. No.: 18/776,807

(22) Filed: Jul. 18, 2024

(30) Foreign Application Priority Data
Aug. 11, 2023 (KR) 10-2023-0105598

(51) Int. Cl. H01G 4/012; H01G 4/232; H01G 4/30

(52) U.S. Cl. CPC H01G 4/012; H01G 4/232; H01G 4/30

(57) ABSTRACT

A multilayer electronic component includes: a body including a dielectric layer, a first internal electrode layer, and a second internal electrode layer alternately disposed in a first direction with the dielectric layer interposed therebetween; a first external electrode disposed on the body, perpendicular to the first direction; and a second external electrode disposed on the body, wherein the first internal electrode layer includes a first internal electrode connected to the first external electrode, and the second internal electrode layer includes a second internal electrode connected to the second external electrode, wherein, when the shortest distance between the first internal electrode and a second internal electrode, most adjacent to the first internal electrode is defined as a, and the maximum size of the first internal electrode in the first direction is defined as te, 0.01≤(a/te)≤1.37 is satisfied.

### CROSS-REFERENCE TO RELATED APPLICATION(S)

This application claims benefit of priority to Korean Patent Application No. 10-2023-0105598 filed on Aug. 11, 2023 in the Korean Intellectual Properties Office, the disclosure of which is incorporated herein by reference in its entirety.

### BACKGROUND

### 1. Technical Field

The present disclosure relates to a multilayer electronic component.

### 2. Description of Related Art

A multilayer ceramic capacitor (MLCC), a multilayer electronic component, may be a chip-type condenser mounted on the printed circuit boards of various types of electronic products, such as an image display device such as a liquid crystal display (LCD) or a plasma display panel (PDP), a computer, a smartphone, a mobile phone, and the like, serving to charge or discharge electricity therein or therefrom.

As electronic products have been designed to have a reduced size, thickness and multifunctionality, chip components have also been required to have a reduced size, and mounting of electronic components has also become highly integrated. In response to this trend, a space between mounted electronic components has also been reduced.

In order for an MLCC to have high capacitance, it may be necessary to use a material with a high dielectric constant as a material of a dielectric layer, or design to reduce a thickness of the dielectric layer. However, an MLCC has many characteristics which should be satisfied at the same time, such as temperature characteristics, voltage characteristics, and moisture-resistance reliability, in addition to capacitance, so there is a limit to reducing the thickness of the dielectric layer.

Therefore, there is a need for structural improvement of an MLCC that can improve capacitance per unit volume without deteriorating reliability thereof.

### SUMMARY

An aspect of the present disclosure is to improve capacitance per unit volume of a multilayer electronic component.

An aspect of the present disclosure is to improve capacitance per unit volume of a multilayer electronic component without deteriorating reliability thereof.

According to an aspect of the present disclosure, a multilayer electronic component, includes a body including a dielectric layer, a first internal electrode layer, and a second internal electrode layer alternately disposed in a first direction with the dielectric layer interposed therebetween; a first external electrode disposed on a first surface among two surfaces of the body opposing each other in a second direction, which is perpendicular to the first direction; and a second external electrode disposed on a second surface among the two surfaces of the body opposing each other in the second direction, wherein the first internal electrode layer includes a first internal electrode connected to the first external electrode and disposed to be spaced apart from each other in a third direction, which is perpendicular to the first direction and the second direction, and the second internal electrode layer includes a second internal electrode connected to the second external electrode and disposed to be spaced apart from each other in the third direction, wherein, when a shortest distance between the first internal electrode and a second internal electrode that is closest to the first internal electrode is defined as a, and a maximum size of the first internal electrode in the first direction is defined as te, 0.01≤(a/te)≤1.37 is satisfied.

According to an aspect of the present disclosure, a method of manufacturing a multilayer electronic component includes applying a conductive material at first intervals along a direction on a first dielectric ceramic green sheet to form a first conductive pattern; applying the conductive material at second intervals in the direction on a second dielectric ceramic green sheet to form a second conductive pattern; stacking the first dielectric ceramic green sheet on which the first conductive pattern is formed and the second dielectric ceramic green sheet on which the second conductive pattern is formed to form a stack; and pressing and firing the stack.

### BRIEF DESCRIPTION OF DRAWINGS

The above and other aspects, features, and advantages of the present disclosure will be more clearly understood from the following detailed description, taken in combination with the accompanying drawings, in which:

FIG. 1 is a perspective view schematically illustrating a multilayer electronic component according to an embodiment of the present disclosure;

FIG. 2 is a perspective view schematically illustrating a body according to an embodiment;

FIG. 3 is a cross-sectional view illustrating a cross-section of a multilayer electronic component in a first direction and a third direction polished to a central portion of a multilayer electronic component in a second direction according to a comparative example;

FIG. 4 is a cross-sectional view taken along line I-I′ in FIG. 1;

FIG. 5 is an enlarged view of area P in FIG. 4;

FIG. 6A and FIG. 6B are each a cross-sectional view illustrating an internal electrode layer according to an embodiment;

FIG. 7 is a cross-sectional view illustrating a cross-section of a capacitance forming portion in first and third directions;

FIG. 8A is a schematic diagram illustrating a direction of an electric field flux between internal electrodes in a multilayer electronic component according to a comparative example, and FIG. 8B is a schematic diagram illustrating a direction of an electric field flux between internal electrodes in a multilayer electronic component according to an example;

FIG. 9A is a schematic diagram illustrating a direction of an electric field flux between internal electrodes in a multilayer electronic component according to a comparative example, and FIG. 9B is a schematic diagram illustrating a direction of an electric field flux between internal electrodes in a multilayer electronic component according to an example;

FIG. 10 is a schematic diagram illustrating a difference in the degree of integration according to a radius of the internal electrode and a distance between internal electrodes in a comparative example and example;

FIG. 11 is a graph illustrating the tendency of reduction in a volume of the multilayer electronic component by summarizing the calculation results according to FIG. 10; and

FIG. 12 is a perspective view illustrating a portion of a process of stacking an internal electrode layer and a dielectric layer according to an embodiment.

### DETAILED DESCRIPTION

Hereinafter, embodiments of the present disclosure will be described as follows with reference to the attached drawings. The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Accordingly, shapes and sizes of elements in the drawings may be exaggerated for clear description, and elements indicated by the same reference numeral are the same elements in the drawings.

In the drawings, irrelevant descriptions will be omitted to clearly describe the present disclosure, and to clearly express a plurality of layers and areas, thicknesses may be magnified. The same elements having the same function within the scope of the same concept will be described with use of the same reference numerals. Throughout the specification, when a component is referred to as “comprise” or “comprising,” it means that it may further include other components as well, rather than excluding other components, unless specifically stated otherwise.

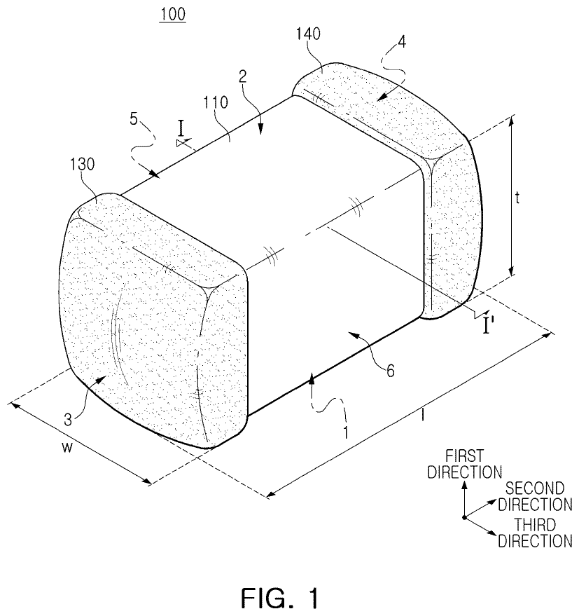

FIG. 1 is a perspective view schematically illustrating a multilayer electronic component according to an embodiment of the present disclosure.

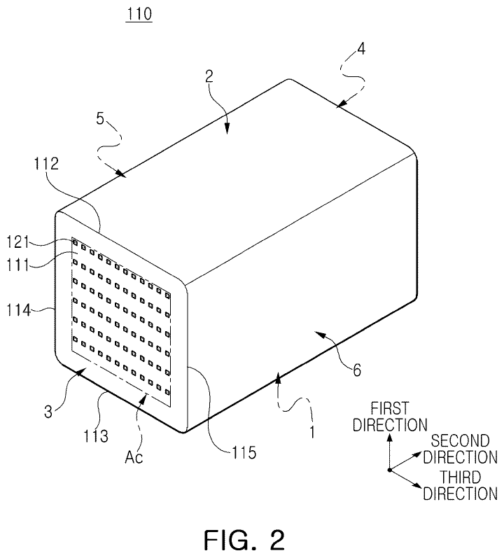

FIG. 2 is a perspective view schematically illustrating a body according to an embodiment.

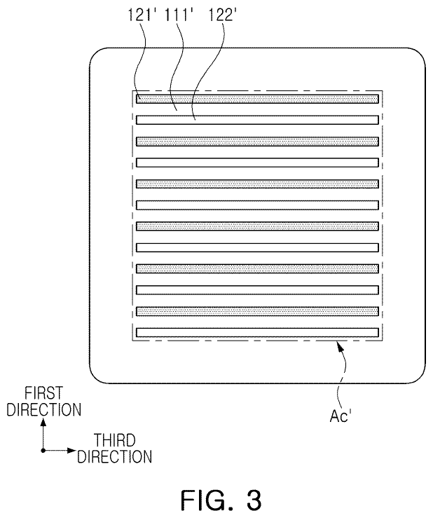

FIG. 3 is a cross-sectional view illustrating a cross-section of a multilayer electronic component in a first direction and a third direction polished to a central portion of a multilayer electronic component in a second direction according to a comparative example.

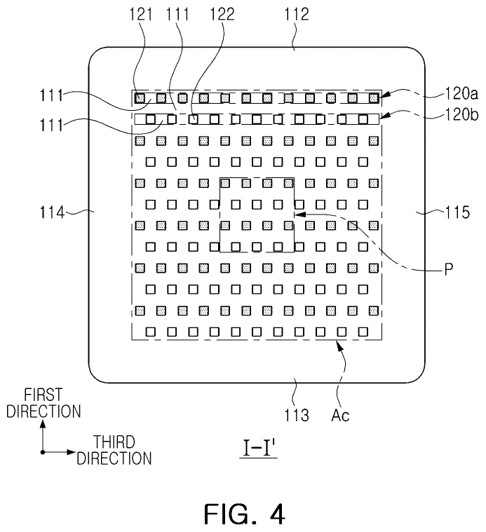

FIG. 4 is a cross-sectional view taken along line I-I′ in FIG. 1.

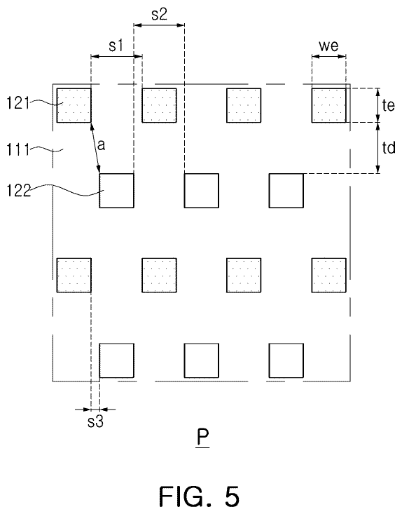

FIG. 5 is an enlarged view of area P in FIG. 4.

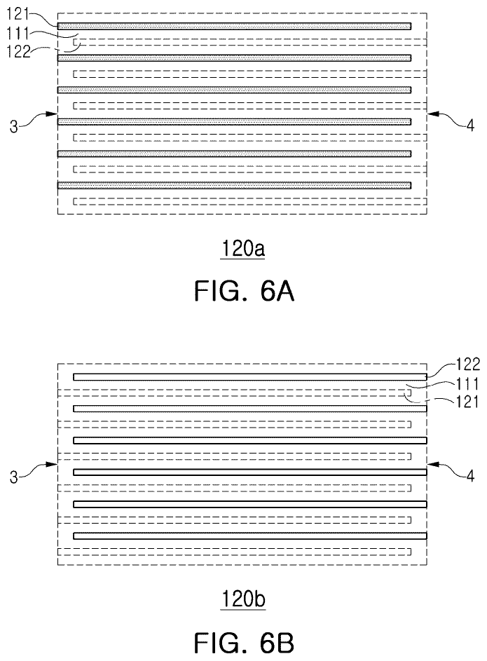

FIGS. 6A and 6B are each a cross-sectional view illustrating an internal electrode layer according to an embodiment.

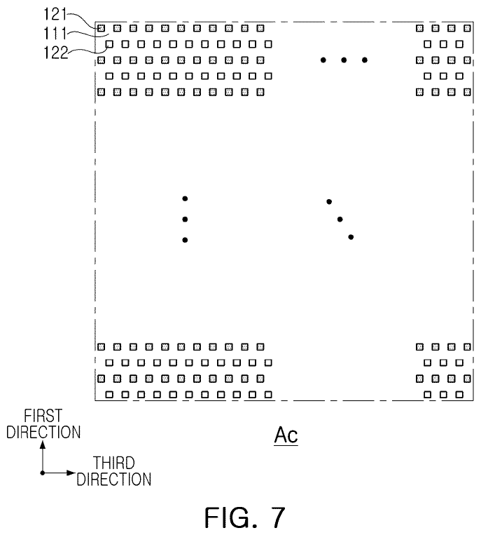

FIG. 7 is a cross-sectional view illustrating a cross-section of a capacitance forming portion in first and third directions.

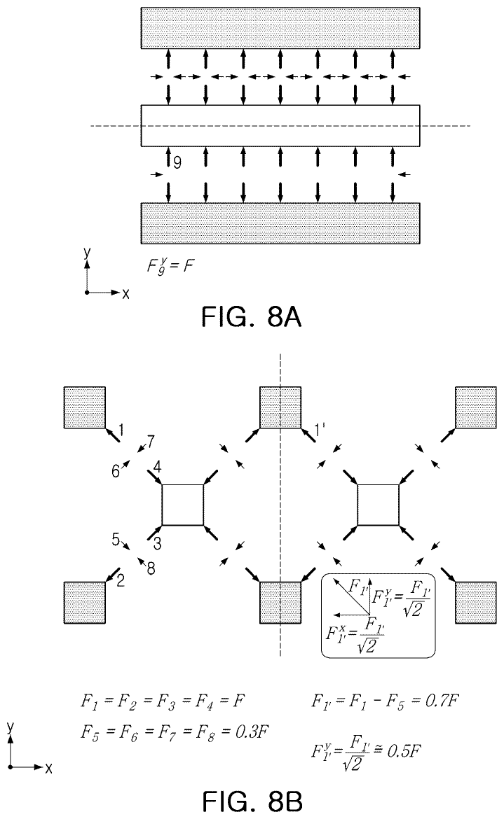

FIG. 8A is a schematic diagram illustrating a direction of an electric field flux between internal electrodes in a multilayer electronic component according to a comparative example, and FIG. 8B is a schematic diagram illustrating a direction of an electric field flux between internal electrodes in a multilayer electronic component according to an example.

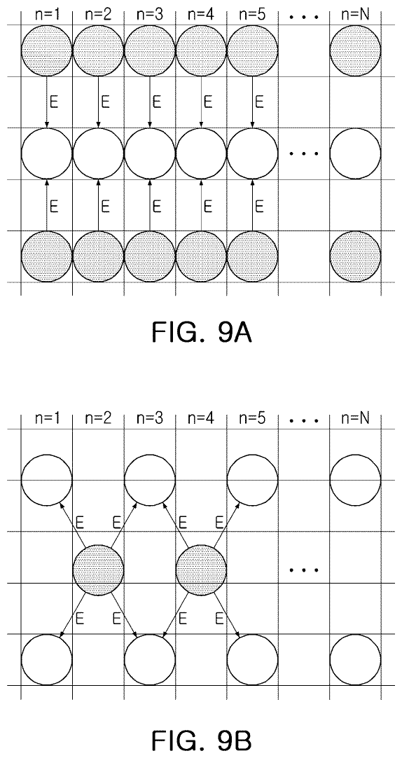

FIG. 9A is a schematic diagram illustrating a direction of an electric field flux between internal electrodes in a multilayer electronic component according to a comparative example, and FIG. 9B is a schematic diagram illustrating a direction of an electric field flux between internal electrodes in a multilayer electronic component according to an example.

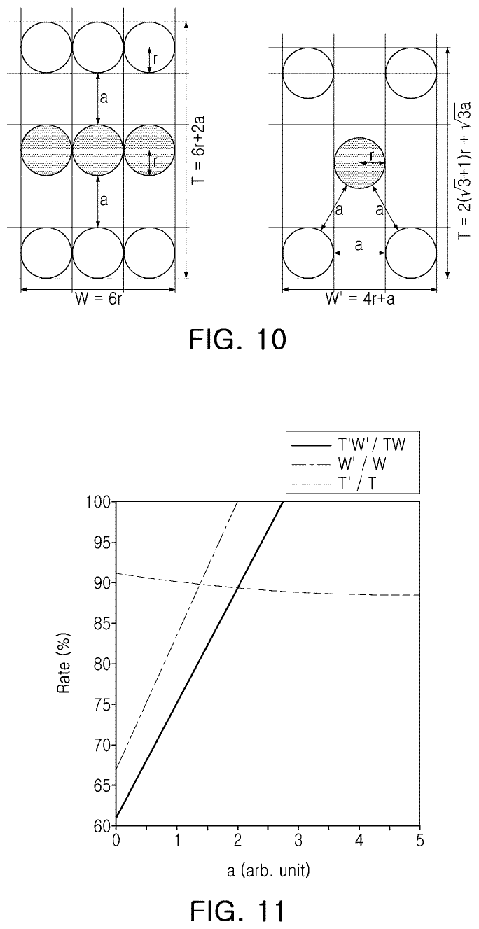

FIG. 10 is a schematic diagram illustrating a difference in the degree of integration according to a radius of the internal electrode and a distance between internal electrodes in a comparative example and example.

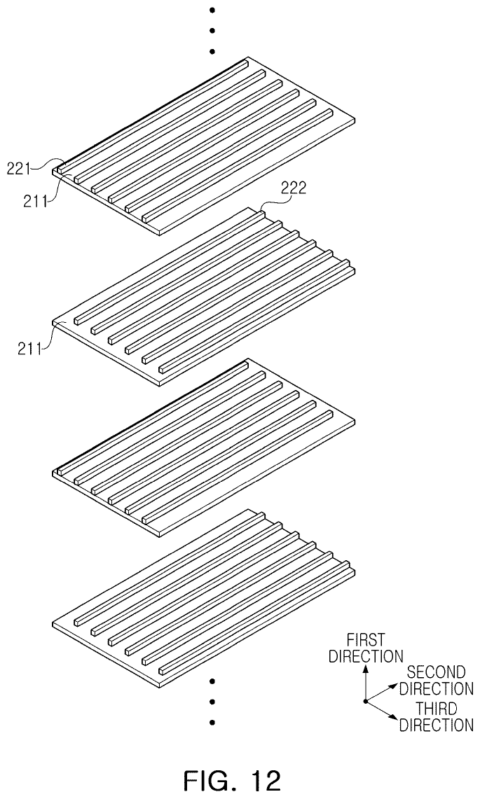

FIG. 11 is a graph illustrating the tendency of reduction in a volume of the multilayer electronic component by summarizing the calculation results according to FIG. 10.

FIG. 12 is a perspective view illustrating a portion of a process of stacking an internal electrode layer and a dielectric layer according to an embodiment.

In the drawings, a first direction may be defined as a direction in which first and second internal electrodes are alternately disposed with a dielectric layer interposed therebetween or a thickness T direction, among second and third directions, perpendicular to the first direction, the second direction may be defined as a length L direction, and the third direction may be defined as a width W direction.

Hereinafter, a multilayer electronic component 100 according to embodiments will be described in greater detail with reference to FIGS. 1 to 12.

According to an embodiment of the present disclosure, a multilayer electronic component 100 includes a body including a dielectric layer, a first internal electrode layer, and a second internal electrode layer alternately disposed in a first direction with the dielectric layer interposed therebetween; a first external electrode disposed on one surface of two surfaces of the body opposing each other in a second direction, perpendicular to the first direction; and a second external electrode disposed on the other surface of two surfaces of the body opposing each other in the second direction, wherein the first internal electrode layer includes a first internal electrode connected to the first external electrode and disposed to be spaced apart from each other in a third direction, perpendicular to the first direction and the second direction, and the second internal electrode includes a second internal electrode connected to the second external electrode and disposed to be spaced apart from each other in the third direction, wherein, when a shortest distance between the first internal electrode and a second internal electrode, most adjacent to the first internal electrode is defined as a, and a maximum size of the first internal electrode in the first direction is defined as te, 0.01≤(a/te)≤1.37 is satisfied.

Referring to FIG. 4, the body 110 includes a dielectric layer 111, a first internal electrode layer 120a, and a second internal electrode layer 120b alternately disposed in a first direction with the dielectric layer 111 interposed therebetween.

The shape of the body 110 may not be limited to any particular shape, but as illustrated in FIG. 2, the body 110 may have a hexahedral shape or a shape similar to a hexahedral shape. Due to contraction of ceramic powder included in the body 110 during a firing process, the body 110 may not have an exact hexahedral shape formed by linear lines but may have a substantially hexahedral shape.

The body 110 may have first and second surfaces 1 and 2 opposing each other in a first direction, third and fourth surfaces 3 and 4 connected to the first and second surfaces 1 and 2 and opposing each other in a second direction, and fifth and sixth surfaces 5 and 6 connected to the first and second surfaces 1 and 2 and the third and fourth surfaces 3 and 4 and opposing each other in a third direction.

A plurality of dielectric layers 111 forming the body 110 may be in a sintered state, and a boundary between the adjacent dielectric layers 111 may be integrated with each other such that the boundary may not be readily apparent without a scanning electron microscope (SEM).

A raw material for forming the dielectric layer 111 is not limited to any particular example as long as sufficient capacitance may be obtained. For example, a barium titanate-based material, a lead composite perovskite-based material, or a strontium titanate-based material may be used. The barium titanate material may include BaTiO₃ ceramic powder, and an example of the ceramic powder may include (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) or Ba(Ti_{1-y}Zr_{y})O₃ (0<y<1) in which Ca (calcium), Zr (zirconium) is partially dissolved.

Accordingly, the dielectric layer 111 may include barium (Ba) and titanium (Ti), and may additionally include calcium (Ca) and zirconium (Zr) according to the depending on the dissolved elements.

In addition, the raw material of the dielectric layer 111 may include various ceramic additives, organic solvents, binders, dispersants, and the like, added to powder such as barium titanate (BaTiO₃) powder, or the like, according to an object of the present disclosure.

The first internal electrode layer 120a and the second internal electrode layer 120b may be alternately disposed with the dielectric layer 111 interposed therebetween, so that the first internal electrode layer 120a and the second internal electrode layer 120b may serve to form capacitance together with the dielectric layer 111. The capacitance of the multilayer electronic component 100 may vary according to a region in which an electric field is formed between the first internal electrode 121 included in the first internal electrode layer 120a and the second internal electrode 122 included in the second internal electrode layer 120b is defined as a capacitance forming portion Ac.

In an embodiment, cover portions 112 and 113 may be disposed on one surface and the other surface of the capacitance forming portion Ac in the first direction.

The cover portions 112 and 113 may be formed by stacking a single dielectric layer or two or more dielectric layers on the upper and lower surfaces of the capacitance forming portion Ac in the thickness direction, respectively, and may serve to basically prevent damages to the internal electrode due to physical or chemical stress.

The cover portions 112 and 113 may not include internal electrodes, and may include the same material as that of the dielectric layer 111. That is, the cover portions 112 and 113 may include a ceramic material, for example, a barium titanate (BaTiO₃) ceramic material.

Meanwhile, an average thickness of the cover portions 112 and 113 may not be limited to any particular example. However, to easily obtain miniaturization and high capacitance of the multilayer electronic component, the average thickness “tc” of the cover portions 112 and 113 may be 15 μm or less.

Here, the average thickness of the cover portions 112 and 113 may refer to a size of the cover portions 112 and 113 in a first direction, and may be a value obtained by averaging sizes of the cover portions 112 and 113 measured at five points at equal intervals in the first direction above or below the capacitance forming portion Ac.

Referring to FIG. 2, in an embodiment, margin portions 114 and 115 may be disposed on one surface and the other surface of the capacitance forming portion Ac in a third direction.

The margin portions 114 and 115 may mean a region between both ends of the first and second internal electrodes 121 and 122 and an interface of the body 110, as illustrated in FIG. 2.

The margin portions 114 and 115 may basically serve to prevent damages to the internal electrodes due to physical or chemical stress.

The margin portions 114 and 115 may be formed by applying a conductive paste to the ceramic green sheet, except where margin portions are to be formed to form an internal electrode.

In addition, in order to suppress a step by the internal electrodes 121 and 122, after the internal electrodes are cut so as to be exposed to the fifth and sixth surfaces 5 and 6 of the body after lamination, the margin portions 114 and 115 may also be formed by stacking a single dielectric layer or two or more dielectric layers on both side surfaces of the capacitance forming portion Ac in the third direction (width direction).

Meanwhile, a width of the margin portions 114 and 115 is not particularly limited. However, in order to more easily implement miniaturization and high capacitance of the multilayer electronic component, an average width of the margin portions 114 and 115 may be 15 μm or less.

The average width of the margin portions 114 and 115 may refer to an average size of the margin portions 114 and 115 in a third direction, and may be a value obtained by averaging sizes of the margin portions 114 and 115 measured at five points at equal intervals in the third direction in terms of the capacitance forming portion Ac.

The internal electrodes 121 and 122 may be alternately disposed in a first direction with the dielectric layer 111 interposed therebetween, and may also be alternately disposed in a third direction. The internal electrodes 121 and 122 may include a first internal electrode 121 connected to the first external electrode 130 and a second internal electrode 122 connected to the second external electrode 140. In this case, the first internal electrode 121 may be disposed to be spaced apart from the second external electrode 140, and the second internal electrode 122 may be disposed to be spaced apart from the first external electrode 130. Accordingly, different voltages may be applied to the first internal electrode 121 and the second internal electrode 122.

Referring to FIG. 6, in an embodiment of the present disclosure, the first internal electrode 121 may be disposed to be spaced apart from each other in a third direction, perpendicular to the first and second directions, and the second internal electrode 122 may be disposed to be spaced apart from each other in the third direction. Accordingly, the plurality of first internal electrodes 121 may be disposed in a first internal electrode layer 120a, and the plurality of second internal electrodes 122 may be disposed in a second internal electrode layer 120b. Meanwhile, the first internal electrode layer 120a and the second internal electrode layer 120b may be alternately disposed with the dielectric layer 111 interposed therebetween, so that the plurality of first internal electrode layers 120a and the plurality of second internal electrode layers 120b may be disposed. Accordingly, the plurality of first internal electrodes 121 may also be disposed in the first direction, and the plurality of second internal electrodes 122 may also be disposed in the first direction, and thus the capacitance per unit volume of the multilayer electronic component 100 may be improved.

Meanwhile, in FIG. 4, it is expressed that the first internal electrode 121 and the second internal electrode 122 are disposed in 6 layers in the first direction and in 12 layers in the third direction, respectively, but the stacking degree of the internal electrodes is not limited thereto. As shown in FIG. 7, the first internal electrode 121 and the second internal electrode 122 may be disposed in 6 or more layers in the first direction and in 12 or more layers in the third direction, and preferably, the first internal electrode 121 and the second internal electrode 122 may be disposed in 25 or more layers in the first or third direction, respectively. That is, the stacking degree of the first internal electrode 121 and the second internal electrode 122 may disposed in 25 or more layers in the first or third direction, respectively.

Meanwhile, the dielectric layer 111 may fill all of a space in which the first internal electrode 121 is spaced apart, a space in which the second internal electrode 122 is spaced apart, and a space in which the first internal electrode layer 120a and the second internal electrode layer 120b are spaced apart. Accordingly, each of the first and second internal electrodes 121 and 122 may be electrically insulated.

The material for forming the internal electrodes 121 and 122 is not limited to any particular example, and a material having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), and alloys thereof.

In addition, the internal electrodes 121 and 122 may be formed by printing a conductive paste for internal electrodes including one or more of nickel (Ni), copper (Cu), palladium (Pd), silver (Ag), gold (Au), platinum (Pt), tin (Sn), tungsten (W), titanium (Ti), and alloys thereof on a ceramic green sheet. A screen printing method or a gravure printing method may be used as a method of printing the conductive paste for internal electrodes, but an embodiment thereof is not limited thereto.

External electrodes 130 and 140 may be disposed on the body 110.

The external electrodes 130 and 140 may be respectively disposed on one surface of two surfaces of the body 110 opposing each other in the second direction.

Specifically, the external electrodes 130 and 140 may include a first external electrode 130 in contact with the third surface 3 of the body 110 and a second external electrode 140 in contact with the fourth surface 4 of the body 110. The first external electrode 130 may be connected to the first internal electrode 121, and the second external electrode 140 may be connected to the second internal electrode 122.

In the embodiment, the multilayer electronic component 100 may have two external electrodes 130 and 140, but the number of the external electrodes 130 and 140 and the shape thereof may be varied depending on the internal electrodes 121 and 122 or for other purposes.

Meanwhile, the external electrodes 130 and 140 may be formed of any material having electrical conductivity, such as metal, and a specific material may be determined in consideration of electrical properties and structural stability, and the external electrodes 130 and 140 may have a multilayer structure.

For example, the external electrodes 130 and 140 may include an electrode layer disposed on the body 110 and a plating layer disposed on the electrode layer.

For a more specific example of the electrode layer, the electrode layer may be a sintered electrode including a conductive metal and glass, or a resin-based electrode including a conductive metal and a resin.

In addition, the electrode layer may have a form in which a sintered electrode and a resin-based electrode are sequentially formed on the body. In addition, the electrode layer may be formed by transferring a sheet including a conductive metal onto a body or by transferring a sheet including a conductive metal onto a sintered electrode.

A material having excellent electrical conductivity may be used as the conductive metal included in the electrode layer and the type of the electrode layers is not limited to any particular example. For example, the conductive metal may be one or more of nickel (Ni), copper (Cu), and alloys thereof, and may preferably copper (Cu) to improve adhesion with the body.

The plating layer serves to improve mounting properties. The type of the plating layers is not limited to any particular example, and may be a plating layer including one or more of nickel (Ni), tin (Sn), palladium (Pd), and alloys thereof, and may be formed of a plurality of layers.

For a more specific example of the plating layers, the plating layer may be a Ni plating layer or a Sn plating layer, the plating layers may have a form in which the Ni plating layer and the Sn plating layer are sequentially formed, and a form in which the Sn plating layer, the Ni plating layer, and the Sn plating layer are sequentially formed. In addition, the plating layer may include a plurality of Ni plating layers and/or a plurality of Sn plating layers.

Hereinafter, the correlation between various parameters for securing the capacitance and/or reliability per unit volume of the multilayer electronic component 100 according to an embodiment or various embodiments of the present disclosure will be described in detail.

Referring to FIG. 5, “a” may represent a shortest distance between a first internal electrode 121 and a second internal electrode 122, most adjacent to the first internal electrode 121. The shortest distance “a” is not limited to a distance thereof in the first to third directions, and may refer to a length of a line segment having the shortest distance among line segments obtained by connecting any outermost point of the first internal electrode 121 and any outermost point of the second internal electrode 122 in the first internal electrode 121 and the second internal electrode 122, adjacent to each other, and the measurement may be performed using a scanning electron microscope (SEM) or an optical microscope (OM) in the cross-section in the first and third directions polished to a central portion of the multilayer electronic component 100 in the second direction, but the present disclosure is not limited thereto.

The shortest distance “a” may have an average value of values measured in the central portion of the capacitance forming portion, which is adjusted so that 10 or more layers of first internal electrodes are provided in the first direction, in the cross-section the multilayer electronic component 100 in the first and third directions polished to the central portion of the multilayer electronic component 100 in the second direction, so that it may be further generalized. That is, “a” may be an average value of the shortest distance between a first internal electrode 121 and the second internal electrode 122, most adjacent to the first internal electrode 121.

Referring to FIG. 5, s1 may refer to a distance between the first internal electrodes 121 in the third direction, s2 may refer to a distance between the second internal electrodes 122 in the third direction, and s3 may refer to a distance between the first internal electrode 121 and the second internal electrode 122 in the third direction. In this case, s1 may refer to a distance between the first internal electrodes 121, adjacent to each other in the third direction, s2 may refer to a distance between the second internal electrodes 122, adjacent to each other, and s3 may refer to a distance between any first internal electrode 121 and any second internal electrode 122, adjacent to any first internal electrode 121, but the present disclosure is not limited thereto. s1, s2, and s3 may be measured using a scanning electron microscope (SEM) or an optical microscope (OM) in the cross-sections in the first and third directions polished to the central portion of the second direction of the multilayer electronic component 100, but the present disclosure is not limited thereto.

The distances s1, s2, and s3 may have an average value of values measured in the central portion of the capacitance forming portion, which is adjusted so that 10 or more layers of first internal electrodes are provided in the first direction, in the cross-section in the first and third directions polished to the central portion of the multilayer electronic component 100 in the second direction, so that it may be further generalized. That is, s1 may refer to an average distance between the first internal electrodes 121 in the third direction, s2 may refer to an average distance between the second internal electrodes 122 in the third direction, and s3 may refer to an average distance between the first internal electrode 121 and the second internal electrode 122 in the third direction.

Referring to FIG. 5, “td” may refer to a distance in the first direction between the first internal electrode 121 and the second internal electrode 122, most adjacent to the first internal electrode in the first direction.

The distance “td” in the first direction between the first internal electrode 121 and the second internal electrode 122 in the first direction may refer to a distance in the first direction of line segments obtained by connecting one end of the first internal electrode 121 in the first direction and one end opposed thereto, among one end of the first internal electrode 121 in the first direction and one end of the second internal electrode 122 in the first direction, in the cross-section in the first and third directions polished to the central portion of the multilayer electronic component 100 in the second direction, and the measurement may be performed using a scanning electron microscope (SEM) or an optical microscope (OM), but the present disclosure is not limited thereto.

The distance “td” may have an average value of values measured at 10 or more internal electrodes in the central region of the capacitance forming portion, which is adjusted so that 10 or more layer of first and second internal electrodes are provided in the first direction, respectively, in the cross-section in the first and third directions polished to the central portion of the multilayer electronic component 100 in the second direction, so that it may be further generalized. That is, “td” may be an average distance in a first direction between a first internal electrode 121 and a second internal electrode 122, most adjacent to the first internal electrode in the first direction.

Referring to FIG. 5, “te” may refer to a maximum size of the first internal electrode 121 in the first direction, and “we” may refer to a maximum size of the first internal electrode 122 in the third direction. In the present specification, the maximum size “te” in the first direction and the maximum size “we” in the third direction are described based on the first internal electrode 121, but the description thereof may be applied to the second internal electrode 122 as well.

According to the specific shape of the first internal electrode 121, the thickness and width of the first internal electrode 121 may be different in each position, so in the present disclosure, the value corresponding to the thickness and width of the first internal electrode 121 was set to be the maximum size “te” of the first internal electrode 121 in the first direction and the maximum size “we” of the first internal electrode 121 in the third direction, respectively. Specifically, in the cross-section in the first and third directions polished to the central portion of the multilayer electronic component 100 in the second direction, the size of a line segment in the first direction obtained by connecting the highest point and the lowest point in the first direction in any one first internal electrode included in the capacitance forming portion may be set to be a maximum size “te” of the first internal electrode 121 in the first direction, and the size of a line segment in the third direction obtained by connecting outermost points in the third direction (maximum point in the + direction, maximum point in the − direction) in any one first internal electrode may be set to have a maximum size “we” of the first internal electrode 121 in the third direction. These measurements may be similarly applied to the second internal electrode 122, and these measurements may be performed using a scanning electron microscope (SEM) or an optical microscope (OM), but the present disclosure is not limited thereto.

The maximum sizes “te” and “we” may have an average value of values measured at 10 or more internal electrodes in the central region of the capacitance forming portion, which is adjusted so that 10 or more layers of first and second internal electrodes are provided in the first direction, respectively, in the cross-section in the first and third directions polished to the central portion of the multilayer electronic component 100 in the second direction, so that it can be further generalized. That is, “te” may refer to an average value of the maximum size of the first internal electrode in the first direction, and “we” may refer to an average value of the maximum size of the first internal electrode in the third direction.

FIG. 8A is a schematic diagram illustrating a direction of an electric field flux between internal electrodes in a multilayer electronic component according to a comparative example, and FIG. 8B is a schematic diagram illustrating a direction of an electric field flux between internal electrodes in a multilayer electronic component according to an example.

When an electric field is applied, a dielectric between the internal electrodes expands in a direction parallel to the electric field and contracts in a direction perpendicular to the electric field. In this case, excessive expansion is induced and a vulnerable layer of a W-margin portion is broken down, which is known as an electrostrictive breakdown phenomenon.

The comparative example in FIG. 8A briefly illustrates a case with a conventional internal electrode of a general type, and FIG. 8B briefly illustrates a case having an internal electrode structure, the same as that of an embodiment of the present disclosure. All expansion/contraction behaviors when an electric field is formed between two electrodes are indicated by thin and thick arrows. The forces expanding in directions 1, 2, 3, and 4 are known as F₁, F₂, F₃, and F₄, respectively, and a magnitude of the force in this case is F, forces which contracts in directions of 5, 6, 7, 8, and 9 may be defined as F₅, F₆, F₇, F₈, F₉, respectively. Assuming that an amount of displacement in the contraction direction is approximately 30% compared to the expansion direction, the magnitude of the force in the contraction direction may be assumed to be 0.3 F. In this case, when calculating a net electrostrictive expansion/contraction force, in the case of the comparative example, the force in the x-axis direction is offset, and a force equal to F (F₉^{y}=F) is applied in the Y-axis direction. In the example, F₁, F₂, F₃ and F₄ are 0.7F, and when those forces are separated into components in the Y-axis direction, F₁, F₂, F₃ and F₄ correspond to about 0.5F(F₁^{-y})=0.5F. Therefore, in the case of the comparative example, it can be predicted that the electrostrictive expansion/contraction force is approximately twice that of the example.

Therefore, as in an embodiment of the present disclosure, in the body 110 including the first internal electrode layer 120a and the second internal electrode layer 120b alternately disposed with the dielectric layer 111 interposed therebetween, when the first internal electrode layer includes a first internal electrode 121 connected to the first external electrode and disposed to be spaced apart from each other in a third direction, perpendicular to the first and second directions, and the second internal electrode layer includes a second internal electrode 122 connected to the second external electrode and disposed to be spaced apart from each other in the third direction, defects in the multilayer electronic component due to electrostrictive breakdown may be relieved as compared to the case of having an internal electrode of a general structure such as the comparative example, by offsetting electrostrictive expansion/contraction.

FIG. 9A is a schematic diagram illustrating the number of electric field fluxes between internal electrodes of a multilayer electronic component according to a comparative example, and FIG. 9B is a schematic diagram illustrating the number of electric field fluxes between internal electrodes of a multilayer electronic component according to an example.

Assuming that the shape of the cross-section of the internal electrode in the first and third directions is circular, intensity E of the electric field shown in the drawing is the same, and three layers are placed as one unit and increased by one unit in the width direction, and all the number of electric field fluxes are calculated, in the case of FIG. 9A, the number of electric field fluxes is 2n, and in the case of FIG. 9B, the number of electric field fluxes is 2n-2. That is, in the case of the comparative example such as the conventional structure and the case of the example such as the structure in an embodiment of the present disclosure, the number of electric field fluxes is only two, so it cannot be considered that there is a significant difference therebetween. Therefore, as in an embodiment of the present disclosure, in the body 110 including the first internal electrode layer 120a and the second internal electrode layer 120b alternately disposed with the dielectric layer 111 interposed therebetween, when the first internal electrode layer includes a first internal electrode 121 connected to the first external electrode and disposed to be spaced apart from each other in a third direction, perpendicular to the first and second directions, the second internal electrode layer has a structure including second internal electrodes 122 connected to the second external electrode and spaced apart from each other in the third direction, although it is possible to relieve defects in the multilayer electronic component due to electrostrictive breakdown, the number of electric field fluxes itself may not be significantly different from the conventional case.

FIG. 10 is a schematic diagram illustrating a difference in the degree of integration according to a radius of an internal electrode and a distance between internal electrodes in a comparative example and an example.

In an embodiment of the present disclosure, 0.01≤(a/te)≤1.37 may be satisfied, and more preferably, 0.01≤(a/te)≤1.10 may be satisfied. Accordingly, in the body 110 including the first internal electrode layer 120a and the second internal electrode layer 120b alternately disposed with the dielectric layer 111 interposed therebetween, when the first internal electrode layer includes a first internal electrode 121 connected to the first external electrode and disposed to be spaced apart from each other in a third direction perpendicular to the first and second directions, and the second internal electrode layer includes a second internal electrode 122 connected to the second external electrode and disposed to be spaced apart from each other in the third direction, it is possible to relieve defects in the multilayer electronic component caused by electrostrictive breakdown and improve capacitance per unit volume.

Specifically, in the case of having a conventional general internal electrode structure and the case of having an internal electrode structure like an embodiment of the present disclosure, in FIG. 10, the shape of the internal electrodes is assumed and expressed to be circular in the cross-section thereof in the first and third directions, a radius of the internal electrode is indicated by r, and a gap between the internal electrodes is indicated by a.

Meanwhile, for convenience of calculation, the cross-sectional shape of the internal electrode is assumed to be circular (radius r) in FIG. 10, and in this case, the relationship between r and te is established as 2r=te. In this case, a length thereof in a W direction calculated in a comparative example is 6r, and a length thereof in a T direction calculated in a comparative example 6r+2a, and a length thereof in a W direction calculated in an example is 4r+a, and a length thereof in a T direction calculated in an example is 2(\sqrt{3}+1)r+\sqrt{3}a.

FIG. 11 specifically illustrates the result of calculating a ratio thereof by setting a radius (r) of the internal electrode to be 1 and adjusting a distance (a). A dashed line corresponds to a ratio in a W direction, a dotted line corresponds to a ratio in a T direction, and a solid line is a product of the W ratio and the T ratio, and corresponds to an area ratio of the WT surface. Comparative examples are indicated by W and T, and examples are indicated by W‘ and T’.

Referring to FIG. 11, it can be seen that when a is 2.74 or less, an area thereof in the example is smaller than that of the comparative example. When converted into a ratio with te corresponding to 2r, it can be seen that if a value of (a/te) is 1.37 or less, the area is smaller than in the conventional case for the same number of stacks. Therefore, in an embodiment of the present disclosure, (a/te)≤1.37 may be satisfied, so that the capacitance per unit volume of the multilayer electronic component may be improved, and more preferably, (a/te)≤1.10 may be satisfied, so that the capacitance per unit volume of the multilayer electronic component may be further improved by having an area ratio of 92.15% or less, as compared to the comparative example. Meanwhile, a lower limit value of (a/te) is not particularly limited, but the lower limit of (a/te) may be preferably 0.01 or more for electrical insulation between internal electrodes.

In an embodiment, 0.9≤s1/s2≤1.1 may be satisfied. Accordingly, an offsetting effect of electrostrictive contraction/expansion may be further improved, and breakdown due to electrostrictive contraction/expansion of the multilayer electronic component 100 may be further relieved.

In an embodiment, the first internal electrode 121 and the second internal electrode 122 may not overlap in the first direction. An example of a structure in which the first internal electrode 121 and the second internal electrode 122 do not overlap in the first direction may include structure in which the first internal electrode 121 and the second internal electrode 122 are spaced apart in the third direction, but the present disclosure is not limited thereto.

As described above, the first internal electrode 121 and the second internal electrode 122 do not overlap in the first direction, which may be advantageous to improve the capacitance per unit volume of the multilayer electronic component 100. However, if the distance in which the first internal electrode 121 and the second internal electrode 122 are spaced apart in the third direction is excessively large, the number of internal electrodes that can be placed per unit volume may be reduced, and as a result thereof, the capacitance per unit volume of the multilayer electronic component 100 may decrease rather than the multilayer electronic component of a conventional general structure. Therefore, in an embodiment, 0<s3≤0.2s1 and 0<s3≤0.2s2 may be satisfied.

Meanwhile, an upper limit of the maximum size “td” of the first internal electrode 121 in the first direction is not particularly limited. However, in order to miniaturize and increase capacitance of the multilayer electronic component 100, the upper limit thereof may be 5 μm or less. A lower limit of the maximum size “td” of the first internal electrode 121 in the first direction is also not particularly limited, but in order to secure an overlap area between the internal electrodes, the maximum size “td” of the first internal electrode 121 in the first direction may be 0.05 μm or more. From a similar perspective thereof, in an embodiment, the maximum size “we” of the first internal electrode 121 in the third direction may be 0.05 μm or more and 5 μm or less.

In an embodiment, te≤td may be satisfied. When a maximum size “te” of the first internal electrode 121 is greater than a distance “td” in the first direction between the first internal electrode and a second internal electrode, most adjacent to the first internal electrode in the first direction, a Fringing Effect may easily occur in the internal electrode. This Fringing effect may cause interference with an electric field generated between the first internal electrode 121 and the second internal electrode 122 in the capacitance forming portion, thereby causing lowering capacitance per unit volume of the multilayer electronic component 100. Accordingly, in an embodiment, by adjusting the maximum size “te” of the first and second internal electrodes 121 to be equal to or smaller than the distance “td” in the first direction between the first internal electrode and a second internal electrode, most adjacent to the first internal electrode in the first direction, the capacitance per unit volume of the multilayer electronic component 100 may be further improved.

In an embodiment, a ≥td may be satisfied. The shortest distance (a) between a first internal electrode 121 and a second internal electrode 122, most adjacent to the first internal electrode 121 is smaller than the distance (a) in the first direction between the first internal electrode and the second internal electrode, most adjacent to the first internal electrode, a failure may occur between the first internal electrode 121 and the second internal electrode 122, most adjacent to the first internal electrode 121. Accordingly, in an embodiment, it is adjusted to satisfy a ≥td, the capacitance per unit volume of the multilayer electronic component 100 may be improved and the withstand voltage characteristics can be improved at the same time.

In an embodiment, 0.5≤te/we≤1.5 may be satisfied, and more preferably 0.9≤te/we≤1.1. Accordingly, by controlling the shapes of the first and second internal electrodes 121 and 122 and efficiently disposing the first and second internal electrodes 121 and 122 in the capacitance forming portion, the capacitance per unit volume of the multilayer electronic component 100 may be further improved.

Meanwhile, in the drawings of the present disclosure, cross-sectional shapes of the internal electrodes 121 and 122 in the first and third directions are expressed as rectangular or square, but the present disclosure not limited thereto. That is, the cross-sectional shapes of the internal electrodes 1212 and 122 in the first and third directions are not particularly limited, and may have various shapes such as polygons, regular polygons, circles, and ellipses.

Referring to FIG. 12, in an embodiment, the dielectric layer 111 and the internal electrode layers 120a and 120b of the present disclosure may be formed through lamination. Specifically, a conductive pattern 221 for forming a first internal electrode may be formed on a dielectric ceramic green sheet 211 at intervals in the third direction, and a conductive pattern 222 for forming a second internal electrode may be formed on the dielectric ceramic green sheet 211 at intervals in the third direction, and repeatedly stacked, and then subjected to a pressing and firing process. The conductive patterns 221 for forming the first and second internal electrodes may be formed by printing, but the present disclosure is not limited thereto, and the conductive patterns 221 for forming the first and second internal electrodes may be formed by attaching a one-dimensional conductive material continuous in the second direction to the dielectric ceramic green sheet 211.

It may not be necessary to specifically limit the size of the multilayer electronic component 100.

However, in order to obtain miniaturization and high capacitance at the same time, to increase the number of laminations by reducing the thickness of the dielectric layer and internal electrode, it may be difficult to secure reliability in the multilayer electronic component 100 having a size of 0201 (length×width, 0.2 mm×0.1 mm) or less.

Accordingly, considering manufacturing errors and the size of external electrode, when the length of the multilayer electronic component 100 is 0.22 mm or less and the width is 0.11 mm or less, the effect of improving reliability according to the embodiment may be more significant.

Here, the length of the multilayer electronic component 100 may refer to the maximum size (L) of the multilayer electronic component 100 in the second direction, the width of the multilayer electronic component 100 may refer to the maximum size (w) of the multilayer electronic component 100 in the third direction, and the thickness of the multilayer electronic component 100 may refer to the maximum thickness (t) of the multilayer electronic component 100 in the first direction. The measurement of the maximum size in each direction may be performed using a scanning electron microscope (SEM) or an optical microscope (OM). Other methods and/or tools appreciated by one of ordinary skill in the art, even if not described in the present disclosure, may also be used.

In an embodiment, t<L may be satisfied. Accordingly, a step difference caused by excessive stacking of the internal electrode layers 120a and 120b may be relieved.

As set forth above, according to the aforementioned embodiments, by improving the degree of integration of the electric field, the capacitance per unit volume may be improved.

According to the aforementioned embodiments, in the internal electrode structure to improve the degree of integration of the electric field, the capacitance per unit volume may be improved without deteriorating reliability.

In the present specification, the expression ‘an embodiment’ used in the present disclosure does not mean the same embodiment, and is provided to emphasize and describe different unique characteristics. However, an embodiment presented above is not excluded from being implemented in combination with features of another embodiment. For example even if a matter described in one specific embodiment is not described in another embodiment, it can be understood as a description related to another embodiment, unless there is a description contradicting or contradicting the matter in the other embodiment.

Terms used in this disclosure are only used to describe one embodiment, and are not intended to limit the disclosure. In this case, singular expressions include plural expressions unless the context clearly indicates otherwise.

While the example embodiments have been illustrated and described above, it will be configured as apparent to those skilled in the art that modifications and variations could be made without departing from the scope of the present disclosure as defined by the appended claims.

What is claimed is:

1. A multilayer electronic component, comprising:
a body including a dielectric layer, a first internal electrode layer, and a second internal electrode layer alternately disposed in a first direction with the dielectric layer interposed therebetween;
a first external electrode disposed on a first surface among two surfaces of the body opposing each other in a second direction, which is perpendicular to the first direction; and
a second external electrode disposed on a second surface among the two surfaces of the body opposing each other in the second direction,
wherein the first internal electrode layer includes a first internal electrode connected to the first external electrode and disposed to be spaced apart from each other in a third direction, which is perpendicular to the first direction and the second direction, and the second internal electrode layer includes a second internal electrode connected to the second external electrode and disposed to be spaced apart from each other in the third direction,
wherein, when a shortest distance between the first internal electrode and a second internal electrode that is closest to the first internal electrode is defined as a, and a maximum size of the first internal electrode in the first direction is defined as te, 0.01≤(a/te)≤1.37 is satisfied.

2. The multilayer electronic component of claim 1, wherein 0.01≤(a/te)≤1.10 is satisfied.

3. The multilayer electronic component of claim 1, wherein the first internal electrode and the second internal electrode do not overlap in the first direction.

4. The multilayer electronic component of claim 1, wherein the first internal electrode and the second internal electrode are disposed to be spaced apart in the third direction.

5. The multilayer electronic component of claim 1, wherein the first internal electrode layer includes a plurality of the first internal electrode, the second internal electrode layer includes a plurality of the second internal electrode, when a distance between adjacent first internal electrodes among the plurality of the first internal electrode in the third direction is defined as s1, and a distance between adjacent second internal electrodes among the plurality of the second internal electrode in the third direction is defined as s2, 0.9≤s1/s2≤1.1 is satisfied.

6. The multilayer electronic component of claim 1, wherein the first internal electrode layer includes a plurality of the first internal electrode, the second internal electrode layer includes a plurality of the second internal electrode, when a distance between adjacent first internal electrodes among the plurality of the first internal electrode in the third direction is defined as s1, a distance between adjacent second internal electrodes among the plurality of the second internal electrode in the third direction is defined as s2, and a distance between one internal electrode among the plurality of the first internal electrode and one internal electrode among the plurality of the second internal electrode in the third direction is defined as s3, 0≤s3≤0.2s1 and 0<s3≤0.2s2 are satisfied.

7. The multilayer electronic component of claim 1, wherein, when a maximum size of the first internal electrode in the third direction is defined as we, we is 0.05 μm or more and 5 μm or less.

8. The multilayer electronic component of claim 1, wherein te is 0.05 μm or more and 5 μm or less.

9. The multilayer electronic component of claim 1, wherein, when a distance in the first direction between the first internal electrode and the second internal electrode that is closest to the first internal electrode in the first direction is defined as td, te≤td is satisfied.

10. The multilayer electronic component of claim 1, wherein, when a distance in the first direction between the first internal electrode and the second internal electrode that is closest to the first internal electrode in the first direction is defined as td, a ≥td is satisfied.

11. The multilayer electronic component of claim 1, wherein, when a maximum size of the first and second internal electrodes in the third direction is defined as we, 0.5≤te/we≤1.5 is satisfied.

12. The multilayer electronic component of claim 1, wherein, when a maximum size of the multilayer electronic component in the first direction is defined as t and a maximum size of the multilayer electronic component in the second direction is defined as L,
t<L is satisfied.

13. The multilayer electronic component of claim 1, wherein the dielectric layer includes Ba and Ti.

14. A method of manufacturing a multilayer electronic component comprising:
applying a conductive material at first intervals along a direction on a first dielectric ceramic green sheet to form a first conductive pattern;
applying the conductive material at second intervals in the direction on a second dielectric ceramic green sheet to form a second conductive pattern;
stacking the first dielectric ceramic green sheet on which the first conductive pattern is formed and the second dielectric ceramic green sheet on which the second conductive pattern is formed to form a stack; and
pressing and firing the stack.

15. The method of claim 14, wherein the conductive material includes a conductive paste.

16. The method of claim 14, wherein the conductive material includes a one-dimensional conductive material.

17. The method of claim 14, wherein the conductive material is a one-dimensional conductive material.
